(19) United States
(12) Patent Application Publication
(10) Pub. No.: US 2023/0119116 A1
(43) Pub. Date: Apr. 20, 2023

(54) METHOD AND PROCESSING APPARATUS FOR DETERMINING OPTIMAL PICK-UP/DROP-OFF LOCATIONS FOR TRANSPORT SERVICE

(71) Applicant: GRABTAXI HOLDINGS PTE. LTD., Singapore (SG)

(72) Inventors: Wenjie XU, Singapore (SG); Mei LENG, Singapore (SG); Sien Yi TAN, Singapore (SG)

(21) Appl. No.: 17/908,348

(22) PCT Filed: Mar. 16, 2020
(86) PCT No.: PCT/SG2020/050139

§ 371 Date: Aug. 31, 2022

(51) Int. Cl. G06Q 10/047; G06Q 10/02; G06Q 50/30; G06N 20/10

(52) U.S. Cl. CPC G06Q 10/047; G06Q 10/02; G06Q 50/30; G06N 20/10

(57) ABSTRACT

An apparatus and method for inferring optimal pick-up/drop-off locations for transport services use historical bookings data associated with past bookings, the past bookings having a pick-up or drop-off location within a defined geographical area. Each historical data instance for a booking includes a geographical data point recorded at a time of a pick-up/drop-off event within the geographical area. The historical data is processed to identify clusters of geographic data points having similar geographical locations. A quality indicator is determined and compared with a first threshold. If the quality indicator satisfies the first threshold, a cluster centroid for each cluster is designated as an optimal pick-up/drop-off location for the geographical area.

### TECHNICAL FIELD

The invention relates generally to the field of communications. One aspect of the invention relates to determining optimal pick-up/drop-off locations for transport services managed by communications systems. Another aspect of the invention relates to a method for mining and filtering historical bookings data for transport services managed by communications systems. Yet another aspect of the invention relates to a method for communicating one or more optimal pick-up/drop-off locations associated with a point of interest for selection by users of transport services managed by communications systems.

### BACKGROUND

Transport-related services, such as taxi rides, are increasingly booked by service users over communications systems. For example, a server apparatus may include a transport service booking platform. Service users (e.g., passengers) may request and book rides between two locations, a pick-up location and drop-off location, on the transport service booking platform using a passenger client application on a user apparatus configured for communication with the server apparatus over a communications network, such as the Internet. In addition, service providers (e.g., drivers) may bid to fulfil booking requests for rides on the transport service booking platform using a driver client application on a user apparatus configured for communication with the server apparatus over the communications network.

Pick-up and drop-off locations for a transport service booking are defined generally, for example, using an address of a building or a point of interest (POI). In consequence, it is sometimes difficult for the passenger to find the driver at the pick-up location and vice versa. For example, a large building may have several entrances, only some of which may be close to a road location where it is convenient for the driver to pick-up/drop-off passengers. Similarly, a POI, such as an outdoor leisure park, may include multiple access points having respective pick-up/drop-off points for passengers. Moreover, a passenger may have a preference to use one of several entrances to a building or access points to a POI, for example, to avoid a long walk to a destination point.

### SUMMARY

Aspects of the invention are as set out in the independent claims. Some optional features are defined in the dependent claims.

One aspect of the invention has particular, but not exclusive, application to transport-related services that are booked and managed by a communications server apparatus. Each transport service booking may identify a pick-up location and a drop-off location to users (e.g., passengers and drivers). Further, implementation of the techniques disclosed herein may determine optimal pick-up/drop-off locations in a defined geographical area (e.g. associated with a point of interest/address) for the transport service.

In at least some implementations, the techniques disclosed herein may mine data related to bookings, in particular location data recorded at a time of pick-up and drop-off events associated with the fulfilment of the respective booking. Thus, the mined location data may be indicative of an actual location of the pick-up and drop-off points used when fulfilling each booking. Typically, the location data may provide a precise geographical location. For example, the location data may be geo-location data including a geographical data point (i.e., latitude and longitude coordinates), with a known degree of accuracy, such as a coordinate location derived from a global navigation satellite system (GNSS).

In at least some implementations, mined location data may be used to determine optimal pick-up/drop-off locations for a point of interest (POI) or address, that may be practical and convenient for service users (e.g., passengers) and service providers (e.g., drivers). The optimal pick-up/drop-off locations may be determined with a high degree of accuracy, thereby enabling passengers and drivers to identify and navigate to the precise pick-up/drop-off point.

In at least some implementations, the optimal pick-up/drop-off locations determined may be communicated to passengers and/or drivers. For example, when a service user requests a booking and specifies points of interest as source and destination points, the optimal pick-up/drop-off locations associated with the respective points of interest may be provided to the service user for selection. The selected optimal pick-up and drop-off locations for the booking may enable improved navigation, by both the service user (e.g., passenger) and service provider (e.g., driver), to precise and convenient locations for the source and destination points for the booking.

The techniques disclosed herein may provide quantitative description about pick-up/drop-off location patterns. For example, for shopping malls, one or two dominant clusters may usually be observed, and from the clusters' probabilities, the preferred choice (e.g., an entrance of the mall for pick-up/drop-off location) may be determined. Another example is a residential area. Residents may get picked up at different blocks. In such a scenario, numerous clusters with small(er) probabilities may be observed.

In an exemplary implementation, the functionality of the techniques disclosed herein may be implemented in software running on a communications server apparatus (server device) configured for managing transport services (e.g., providing a transport service booking platform). When running on the communications server apparatus, the hardware features of the server apparatus may be used to implement the functionality described below, such as using transceiver components to establish secure communications channels. The communications server apparatus may communicate with communications devices of users (client devices) to arrange bookings, the fulfilment of services and so on. The functionality of client devices may be implemented in software running on a handheld communications device, such as a mobile phone. The software which implements the functionality of the techniques disclosed herein may be contained in an “app”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel. As described herein, the user may be a transport service user (e.g., passenger) or a transport service provider (e.g., driver).

### BRIEF DESCRIPTION OF THE DRAWINGS

The invention will now be described, by way of example only, and with reference to the accompanying drawings in which:

FIG. 1 is a schematic block diagram illustrating an exemplary communications system;

FIG. 2A is a flow diagram of a method for determining optimal pick-up/drop-off locations for transport services associated with a point of interest in accordance with an example implementation of the present disclosure;

FIG. 2B shows a schematic block diagram illustrating a processing apparatus for determining optimal pick-up/drop-off locations for transport services at a defined geographical area;

FIG. 3 is a flow diagram of a method for mining and filtering historical bookings data including geographic location data associated with a pick-up or drop-off event at a location associated with a point of interest in accordance with an example implementation of the present disclosure;

FIG. 4 is a flow diagram of a method for determining optimal pick-up/drop-off locations for transport services in accordance with another example implementation of the present disclosure; and

FIGS. 5A-D show maps of data points in a defined geographical area for processing in accordance with an example implementation of the present disclosure.

### DETAILED DESCRIPTION

In the following description, reference will be made to a “pick-up location” and a “drop-off location” associated with the provision of a transport service (e.g., passenger ride). As the skilled person will appreciate, the pick-up location refers to the pick-up point, origin or starting location for the transport service, which the transport service provider must navigate to and wait at, and service user must navigate to in order to access the transport service (i.e., embark from the vehicle). Similarly, the drop-off location refers to the drop-off point, destination or finishing location for the transport service, which the transport service provider must navigate to.

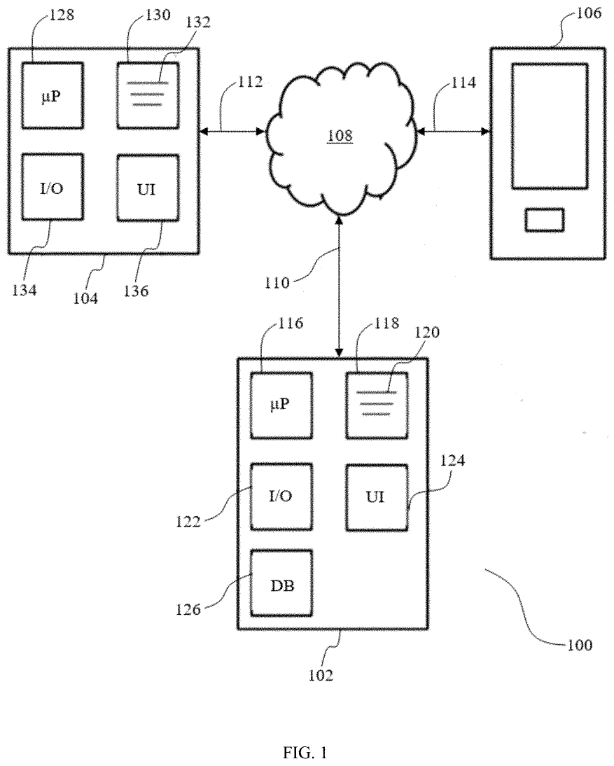

Referring first to FIG. 1, a communications system 100 is illustrated, which may be applicable in various embodiments. The communications system 100 may be for determining optimal pick-up/drop-off locations for transport services at a defined geographical area.

The communications system 100 includes communications server apparatus (server device) 102, a first client communications apparatus (first client device) 104 and a second client communication apparatus (second client device) 106 connected to a communications network 108 (for example the Internet) through respective communications links 110, 112, 114 implementing, for example, internet or other data communications protocols. Communications network 108 may include any wired and/or wireless communications network or combination of networks. Thus, client devices 104, 106 may be able to communicate with server device 102 through various communications networks, such as public switched telephone networks (PSTN networks), mobile cellular communications networks (3G, 4G or LTE networks), local wired and wireless networks (LAN, WLAN, WiFi networks) and the like.

Server device 102 may be a single server as illustrated schematically in FIG. 1, or its functionality may be distributed across multiple servers. For example, server device 102 may include multiple servers. In the example of FIG. 1, server device 102 may include a number of individual components including, but not limited to, one or more microprocessors (μP) 116, a memory 118 (e.g. a volatile memory such as a RAM (random access memory)) for the loading of executable instructions 120, the executable instructions defining the functionality of the server 102 carries out under control of the processor 116. Server device 102 may also include an input/output (I/O) module 122 allowing the server 102 to communicate over the communications network 108. User interface (UI) 124 is provided for user control and may include, for example, one or more computing peripheral devices such as display monitors, computer keyboards and the like. Server device 102 may also include a database (DB) 126, the purpose of which will become readily apparent from the following discussion.

The server device 102 may be for determining optimal pick-up/drop-off locations for transport services at a defined geographical area.

First client device 104 may include a number of individual components including, but not limited to, one or more microprocessors (μP) 128, a memory 130 (e.g. a volatile memory such as a RAM) for the loading of executable instructions 132, the executable instructions 132 defining the functionality the client device 104 carries out under control of the processor 128. First client device 104 also includes an I/O module 134 allowing the client device 104 to communicate over the communications network 108. A user interface (UI) 136 is provided for user control. If the first client device 104 is, say, a portable communications device such as a smart phone or tablet device, the user interface 136 may have a touch panel display as is prevalent in many smart phone and other handheld devices. Alternatively, if the first client device 104 is, say, a desktop or laptop computer, the user interface may have, for example, one or more computing peripheral devices such as display monitors, computer keyboards and the like. User interface 136 may also include a microphone and the like.

Second client device 106 may be, for example, a smart phone or tablet device with the same or a similar hardware architecture to that of first client device 104. In example implementations, first client device 104 may be a user device of a consumer of a service associated with server device 102 (e.g., passenger of a taxi service), and second client device 106 may be a user device of a service provider of a service associated with server device 102 (e.g., driver providing a taxi service). In other example implementations, first and second client devices 102, 104 may be user devices of the same or different categories of user associated with one or more functionalities of the server device 102.

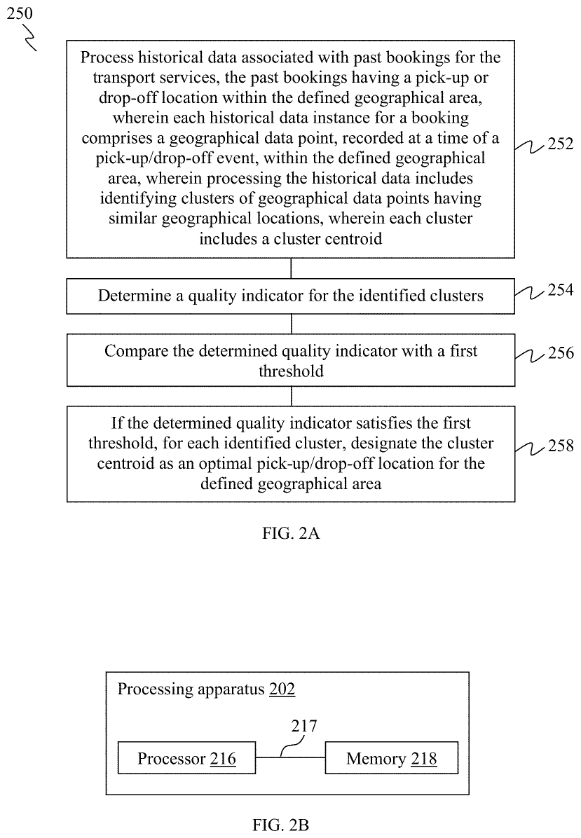

FIG. 2A is a flow diagram illustrating a method 250 for determining optimal pick-up/drop-off locations for transport services in accordance with an example implementation of the present disclosure. The method 250 may be used for determining optimal pick-up/drop-off locations for transport services at a defined geographical area. In the illustrated implementation, the method determines optimal pick-up/drop-off locations for a geographical point of interest. The method 250 may be performed by a communications server apparatus configured to manage transport service bookings (e.g., hosting a transport service booking platform) or an associated processing device.

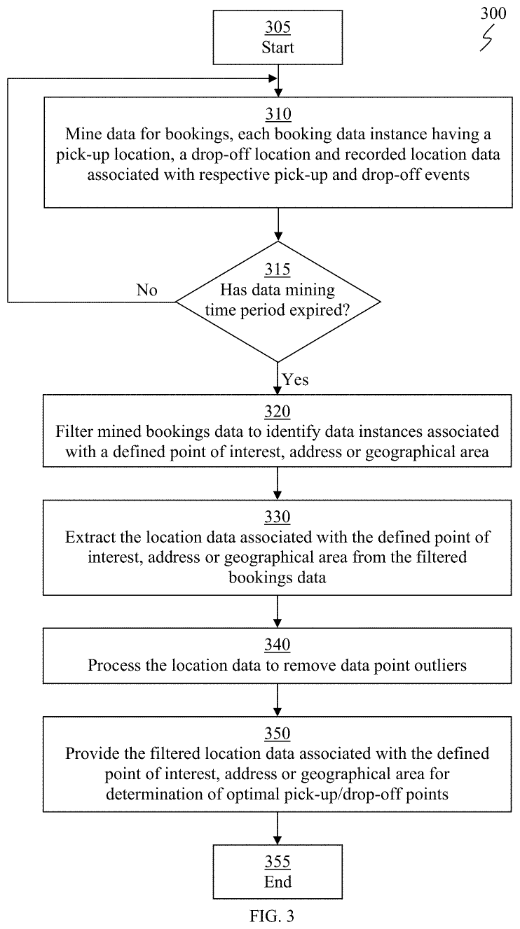

The method 250 may rely on the prior mining of data from fulfilled bookings for transport services, for example, data mining performed by a communications server apparatus hosting a transport service booking platform. In the illustrated example, the method may use data for fulfilled service bookings having the point of interest as either the pick-up location or the drop-off location. The data for each fulfilled booking may include geographical location data, in particular a geographical data point (e.g., a latitude and longitude coordinate pair), associated with a time of a pick-up or drop-off event at the point of interest. For example, the location data may be geo-location data determined by a GNSS navigation system. An example of a method for mining historical data including the geographical location data (i.e., data points) is described below with reference to FIG. 3.

The method 250 may start when optimised pick-up/drop-off locations need to be determined for a point of interest. Thus, the method 250 may be performed at periodic intervals or in response to a manual or automatic triggering event indicating that new or revised optimal pick-up/drop-off locations is to be determined for the point of interest.

At 252, historical data associated with past bookings for transport services are processed, the past bookings having a pick-up or drop-off location within the defined geographical area, wherein each historical data instance for a booking includes a geographical data point, recorded at a time of a pick-up/drop-off event, within the defined geographical area. Processing the historical data includes identifying clusters of geographical data points having similar geographical locations, wherein each cluster includes a cluster centroid. As a non-limiting example, the historical booking data may include data for a plurality of past bookings with the point of interest as the pick-up or drop-off location having location data associated with the time of a pick-up/drop-off event at the point of interest. The received historical booking data may include mined data to be described below with reference to FIG. 3, which may have been filtered to include only booking data instances for past bookings that include geographic location data associated with the time of the pick-up/drop-off event at the point of interest.

In some example implementations, the historical booking data may be further filtered to remove data instances for which the location data has a low accuracy (e.g., GNSS accuracy/confidence indicator below a threshold distance, such as 35 metres). GNSS pings' (e.g., GPS pings) data come with accuracy/confidence indicator. Using Google map as a non-limiting example, generally, a blue dot which pinpoints the current location may be provided. There may also be a light blue region centered with the blue dot and this indicates how accurate the blue dot could be. The larger the light blue region, the less accurate the blue dot. GNSS pings' accuracy/confidence indicator is represented by the radius of the blue region with meter as its unit.

At 252, for identifying the clusters of geographical data points having similar geographical locations, cluster analysis may be performed using a clustering algorithm to identify groups of data points that are in close proximity to each other (i.e., clustering based on similarity of geographic location). In one example implementation, a mean shift clustering algorithm may be employed to identify clusters of geographical data points. Accordingly, step 252 may iteratively group the geographical data points into clusters by mean shift clustering, for example, according to a predetermined number of iterations or until an iteration does not change the result of the previous iteration. In other example implementations, any other suitable clustering algorithm may be used, for example, OPTICS, DBSCAN, K-means clustering, Gaussian mixtures clustering, etc. Further suitable clustering algorithms may be as described at https://en.wikipedia.org/wiki/Cluster_analysis.

At 254, a quality indicator (or a quality score) may be determined for the clusters identified at 252. The quality indicator may be a measure of the quality of the clusters (e.g., how well the clusters are defined, e.g., a measure of the density of the clusters and separation between the clusters). Higher quality or better-defined clusters may be denser clusters (e.g., data points in a cluster may be closer together). The quality indicator may be calculated according to a predefined formula based on one or more parameters associated with the identified plurality of clusters. Example parameters may include average density of the plurality of clusters, maximum radius of the clusters and silhouette coefficient, and the like.

In an example implementation, in which step 252 uses a mean shift clustering algorithm, the quality indicator may be determined, at 254, as a function of mean shift bandwidth, maximum probability of clusters, average density of clusters and clusters' silhouette score (or coefficient). For example, the quality indicator (or quality score) may be determined using the formula:

$$quality\_score = \sqrt{\frac{{( ms\_bandwidth / 10 )}^{1 / 3}}{max\_cluster {\_prob}^{2} \times avg\_density \times {sh\_score}^{2}} ,} \qquad Equation ( 1 )$$

where:
avg_density=average density of clusters, this being equal to (total number of geographical data points in clusters/total areas of clusters),
ms_bandwidth=mean shift bandwidth (i.e., maximum cluster radius),
sh_score=silhouette coefficient of clusters (where the score is higher when clusters are dense and well separated) (https://scikit-learn.org/stable/modules/clustering.html#silhouette-coefficient),
max_cluster_prob=maximum probability of clusters (i.e., the probability of the cluster with the largest probability among one or more clusters).

At step 256, the determined quality indicator may be compared with a first threshold (e.g., “quality threshold”) for determining whether the determined quality indicator satisfies the quality threshold. As a non-limiting example, using Equation (1) above, a lower quality indicator may be indicative of better-defined/higher quality clusters. The quality threshold may be predetermined by a heuristic and cumulative distribution function of the quality indicator and/or may be configurable according to application requirements.

At 258, if the quality indicator is determined to satisfy the first threshold, then the quality of the clusters may be acceptable such that optimal pick-up/drop-off locations may be determined—by inference—from the clusters. If the quality threshold is satisfied, for each identified cluster, the cluster centroid is designated as an optimal pick-up/drop-off location for the defined geographical area. A cluster centroid is a locally densest point for the cluster. Thus, the cluster centroid is a geographical data point where the cluster has the highest number of data points. As a non-limiting example, the method 250 may select a first cluster of the plurality of clusters, and determine a cluster centroid for the cluster. The method 250 may then do the same for a second cluster, a third cluster, and so on.

If it is determined that the quality indicator does not satisfy the first threshold, then the identified clusters are not of sufficient quality to infer optimal pick-up/drop-off locations with the required level of accuracy, and the method ends in relation to the clusters identified at 252.

In various embodiments of the method 250, prior to identifying the clusters of geographical data points having similar geographical locations at 252, data points determined to be outliers may be removed. Outliers may be data points that may be defined in areas of low density of data points and/or data points that may be sufficiently away (e.g., exceeding a defined distance threshold) from the cluster centroid.

In various embodiments, at 254, the method 250 may, for each identified cluster, determine a probability value for the cluster (e.g., the cluster's probability), wherein the probability value may be a measure of the closeness of the geographical data points to the cluster centroid (i.e., how near the data points are to the cluster's centroid, and, for example, a higher probability value may indicate a lot of data points near that cluster's centroid), compare the determined probability value with a second threshold, and, if the determined probability value satisfies the second threshold, designate the identified cluster as a significant cluster. A significant cluster may refer to a cluster having a probability value (or cluster probability) higher than a defined threshold, e.g., more than 0.15. The method 250 may then determine the quality indicator for the significant clusters. At 258, if the determined quality indicator satisfies the first threshold, for each identified cluster designated as the significant cluster, the cluster centroid may be designated as the optimal pick-up/drop-off location for the defined geographical area.

The quality indicator for the significant clusters may be determined using Equation (1). In other words, the term “cluster” in relation to Equation (1) above may be replaced by the term “significant cluster” for computing the quality indicator.

As a non-limiting example, a cluster probability may be determined by integrating the probability density function over the boundary box of the cluster. In one example implementation, kernel density estimation (KDE) may be used, in which a kernel density function may be fitted to the cluster point cloud, to obtain the 2D probability density function over the coordinate space. For example, driver side (DAX) GNSS pings (point cloud) may be divided into different groups (clusters) by mean shift clustering algorithm. Then, a kernel density function may be fitted to this point cloud and as a result, a 2D probability density function over 2D space may be obtained. Each cluster's probability may be computed via integrating the probability density function over the boundary box of the respective cluster. In some example implementations, the optimal pick-up/drop-off locations' confidence level may be assessed quantitatively by the probability values.

Each geographical data point may have a specified accuracy, and the method 250 may further include removing data points having a specified accuracy less than a threshold accuracy level.

In various embodiments, prior to processing the historical data associated with past bookings for the transport services at 252, the method 250 may include mining data associated with past bookings for the transport services, wherein each historical data instance for a booking may include a geographical data point recorded at a time of a pick-up/drop-off event, and filter the mined data to identify data instances for bookings, in which one of the geographical data points, corresponding to a pick-up or drop-off location for the booking, is within the defined geographical area. Further detail will be provided below with reference to FIG. 3.

In various embodiments, the defined geographical area may correspond to a point of interest or address. The method 250 may further include, in response to a booking request from a service user for a transport service indicating the point of interest or address as the pick-up or drop-off location, communicating the determined optimal pick-up/drop-off locations to a client device of the service user for selection by the service user of one of the optimal pick-up/drop-off locations for the booking.

In the above example implementation, one or more data points may be determined as optimal pick-up/drop-off locations for a particular point of interest, using geographic data for past bookings, in which the point of interest is the specified pick-up or drop-off point. As the skilled person will appreciate, it is not essential that the past bookings data include the point of interest as the pick-up/drop-off point. Rather, past bookings data having source or destination locations (e.g., location data points) within a predefined distance of the point of interest may be used.

In other example implementations, the method may be used without reference to particular known points of interest. For example, the method may be used to identify clusters of location data points within a defined geographical area, and determine data points as optimal pick-up/drop-off locations within the geographical area. In particular, the method may process historical booking data, in which the location data, associated with the pick-up or drop-off time, includes a data point within the defined geographical area. Thus, new points of interest may be identified based on raw location data associated with actual pick-up/drop-off locations used in the provision of transport services (e.g., rides) for past transport service bookings.

FIG. 2B shows a schematic block diagram illustrating a processing apparatus 202 for determining optimal pick-up/drop-off locations for transport services at a defined geographical area. The processing apparatus 202 includes a processor 216 and a memory 218, where the processing apparatus 202 is configured, under control of the processor 216 to execute instructions in the memory 218 to, process historical data associated with past bookings for the transport services, the past bookings having a pick-up or drop-off location within the defined geographical area, wherein each historical data instance for a booking has a geographical data point, recorded at a time of a pick-up/drop-off event, within the defined geographical area, wherein, for processing historical data, the apparatus 202 is configured to identify clusters of geographical data points having similar geographical locations, wherein each cluster includes a cluster centroid, determine a quality indicator for the identified clusters, compare the determined quality indicator with a first threshold, and, if the determined quality indicator satisfies the first threshold, to designate, for each identified cluster, the cluster centroid as an optimal pick-up/drop-off location for the defined geographical area. The processor 216 and the memory 218 may be coupled to each other (as represented by the line 217), e.g., physically coupled and/or electrically coupled.

The processing apparatus 202 may determine optimal pick-up/drop-off locations for transport services within a defined geographical area as in the method 250 of FIG. 2. Further, the processing apparatus 202 may be configured to mine and filter bookings data for transport service bookings as in the method 300 of FIG. 3 to be described below.

The processing apparatus 202 may be a communications server apparatus, and may, for example, be as described in the context of the server device 102 (FIG. 1). The processor 216 may be as described in the context of the processor 116 (FIG. 1) and/or the memory 218 may be as described in the context of the memory 118 (FIG. 1).

The processing apparatus 202 may remove data points determined to be outliers, prior to identifying the clusters of geographical data points having similar geographical locations.

For identifying the clusters of geographical data points having similar geographical locations, the processing apparatus 202 may perform cluster analysis using a mean shift clustering algorithm.

For determining the quality indicator for the identified clusters, the processing apparatus 202 may determine the quality indicator as a function of mean shift bandwidth, maximum probability of the clusters, average density of the clusters and silhouette coefficient of the clusters.

For determining the quality indicator for the identified clusters, the processing apparatus 202 may, for each identified cluster, determine a probability value for the cluster, wherein the probability value is a measure of the closeness of the geographical data points to the cluster centroid, compare the determined probability value with a second threshold, and if the determined probability value satisfies the second threshold, designate the identified cluster as a significant cluster, and the processing apparatus 202 may further determine the quality indicator for the significant clusters. If the determined quality indicator satisfies the first threshold, for designating the cluster centroid as the optimal pick-up/drop-off location, the processing apparatus 202 may designate, for each identified cluster designated as the significant cluster, the cluster centroid as the optimal pick-up/drop-off location for the defined geographical area.

The processing apparatus 202 may determine the probability value for the cluster by performing kernel density estimation (KDE) to obtain the 2D probability density function over the coordinate space of the cluster.

In various embodiments, each geographical data point has a specified accuracy, and the processing apparatus 202 may remove data points having a specified accuracy less than a threshold accuracy level.

Prior to processing the historical data associated with past bookings for the transport services, the processing apparatus 202 may mine data associated with past bookings for the transport services, wherein each historical data instance for a booking includes a geographical data point recorded at a time of a pick-up/drop-off event, and filter the mined data to identify data instances for bookings, in which one of the geographical data points, corresponding to a pick-up or drop-off location for the booking, is within the defined geographical area.

In various embodiments, the defined geographical area corresponds to a point of interest or address, and the processing apparatus 202 may, in response to a booking request from a service user for a transport service indicating the point of interest or address as the pick-up or drop-off location, communicate the determined optimal pick-up/drop-off locations to a client device of a service user for selection by the service user of one of the optimal pick-up/drop-off locations for the booking.

There may be provided a computer program product having instructions for implementing a method for determining optimal pick-up/drop-off locations for transport services at a defined geographical area as described herein.

There may also be provided a computer program having instructions for implementing a method for determining optimal pick-up/drop-off locations for transport services at a defined geographical area as described herein.

There may further be provided a non-transitory storage medium storing instructions, which, when executed by a processor, cause the processor to perform a method for determining optimal pick-up/drop-off locations for transport services at a defined geographical area as described herein.

Various embodiments may further provide a communications system for determining optimal pick-up/drop-off locations for transport services at a defined geographical area, having a communications server apparatus, at least one user communications device and communications network equipment operable for the communications server apparatus and the at least one user communications device to establish communication with each other therethrough, wherein the communications server apparatus includes a first processor and a first memory, the communications server apparatus being configured, under control of the first processor, to process historical data associated with past bookings for the transport services, the past bookings having a pick-up or drop-off location within the defined geographical area, wherein each historical data instance for a booking includes a geographical data point, recorded at a time of a pick-up/drop-off event, within the defined geographical area, wherein, for processing historical data, the communications server apparatus is configured to identify clusters of geographical data points having similar geographical locations, wherein each cluster includes a cluster centroid, determine a quality indicator for the identified clusters, compare the determined quality indicator with a first threshold, and if the determined quality indicator satisfies the first threshold, to designate, for each identified cluster, the cluster centroid as an optimal pick-up/drop-off location for the defined geographical area, wherein the at least one user communications device includes a second processor and a second memory, the at least one user communications device being configured, under control of the second processor, to execute second instructions in the second memory to, in response to receiving user booking request data for a transport service from a service user of the at least one user communications device, the user request data including a data field indicative of a point of interest or address corresponding to the defined geographical area, and the point of interest or address being the pick-up or drop-off location, communicate data indicative of the user booking request data to the communications server apparatus, and, wherein, in response to receiving the data indicative of the user booking request data, the communications server apparatus is configured to communicate the determined optimal pick-up/drop-off locations to the at least one user communications device for selection by the service user of one of the optimal pick-up/drop-off locations for the booking.

FIG. 3 illustrates a method 300 for mining and filtering historical data for past bookings, including geographic location data associated with a pick-up or drop-off event in accordance with an example implementation of the present disclosure. In particular, the method 300 may be used for providing the historical booking data that is processed at 252 of the method 250 of FIG. 2A. Thus, the method 300 mines historical booking data for a plurality of past/fulfilled transport service bookings, each booking data instance having location data associated with the time of the pick-up/drop-off event of the booking. The method 300 may further filter the mined data to identify booking data instances with a particular point of interest (or geographical area) as the pick-up or drop-off location.

The method 300 starts at 305. At 310, data associated with bookings of transport services, such as taxi rides and/or ride-hailing services, may be mined. As an example, as described above, a communication server apparatus implementing a transport services booking platform/management system may store data associated with bookings. Each booking may include data including a defined point of interest or address associated with pick-up location corresponding to the origin of the ride and a defined point of interest or address associated with a drop-off location corresponding to the destination of the ride. In addition, each booking may include data associated with the transport service provider that fulfilled the service booking, including (or from which can be derived) an approximate pick-up time at the origin and drop-off time at the destination at the moment that, for example, the driver may press a button (e.g., via an App/application for the service booking) to notify the system that the driver has picked up or dropped off the passenger. Then, the system may record the GNSS ping (e.g., GPS ping) at the moment the button is pressed.

In accordance with an example implementation, a system of GNSS pings or similar geo-location techniques is implemented at 310, triggered by the transport services booking platform and/or associated transport provider client application, at the time of a pick-up event and a drop-off event. For example, a GNSS ping (e.g., “GPS ping”) from the service providers' (drivers') client devices running the client application may be sent to the transport services booking platform when the drivers provide indication of a pick-up event and a drop-off event, for example, by pressing a corresponding button on or via the client application/App. The GNSS ping has location data in the form of a GNSS data point (e.g., latitude and longitude coordinates) at the time of a pick-up and drop-off event. Thus, data instances of the mined bookings data each include location data points associated with the pick-up and drop-off locations, respectively.

The method 300 may, at 315, periodically determine whether a data mining time period has expired. For example, a data mining time period may be defined by a predetermined time period (e.g., in days, weeks or months) or a defined number of bookings within a geographical area. If it is determined, at 315, that a data mining time period has expired, the method 300 proceeds to 320. Otherwise, the method 300 returns to 310 which continues to perform data mining.

The method 300 may, at 320, filter the mined booking data to derive booking data instances that have a particular point of interest, address, geographical area or the like as one of the pick-up and drop-off locations of the booking. In some example implementations, at 320, a name or address of the point of interest may be compared to the corresponding data values included in the mined booking data instances. In addition, or alternatively, at 320, the location data points associated with pick-up and drop-off events of the mined booking instances may be compared with a defined geographical area of interest.

At 330, the method 300 may extract the location data (e.g., location data points) associated with the defined point of interest, address or geographical area from the filtered bookings data.

At 340, the method 300 may process the location data extracted from the filtered bookings data to remove location data point outliers. In an example implementation, at 340, the data may be processed using a DBSCAN clustering algorithm, which may, for example, categorise data points into core points, border points and outliers as will be described further below. Thus, location data points categorised as outliers by the DBSCAN clustering algorithm can be readily removed from the data for further processing. Data points that are determined to be outliers are generally not taken into consideration for the purposes of the present disclosure, including, for the purpose of determining optimal pick-up/drop-off locations. It should be appreciated that the method 300, at 340, involves filtering the bookings data to remove data point outliers, rather than determining clusters of data points.

At 350, the method 300 may provide the filtered historical bookings data associated with the point of interest, address or geographical area for storage and/or further processing. For example, at 350, the filtered data may be stored and/or the filtered data may be provided for processing at 252 of the method 250 of FIG. 2A. The method 300 then ends at 355.

Accordingly, there is provided a method for inferring optimal pick-up/drop-off locations for transport services (e.g., rides) using mined historical bookings data, which may be performed in a communications server apparatus hosting a transport service management system. Historical data associated with past bookings for the transport service is processed, the past bookings having a pick-up or drop-off location within a defined geographical area. Each historical data instance for a booking includes a geographical data point recorded at a time of a pick-up/drop-off event within the defined geographical area. The historical data is processed to identify clusters of geographical data points having similar geographical locations. Each cluster includes a cluster centroid. A quality indicator for the identified clusters is determined. The determined quality indicator is compared with a first threshold. If the determined quality indicator satisfies the first threshold, the cluster centroid for each cluster is designated as an optimal pick-up/drop-off location for the geographical area.

Various embodiments or techniques will now be further described in detail.

Techniques disclosed herein may be employed for determining or inferring optimal pick-up locations and/or drop-off locations, e.g., in the context of ride-hailing services, using GNSS pings (e.g., GPS pings), which may, for example, be obtained via the relevant App (or application) on the driver side (DAX) and/or the passenger side (PAX)) recorded at the moment/time when the DAX/PAX notifies the system that pick-up has occurred at the pick-up/origin locations and/or drop-off has occurred at the drop-off/destination locations. The techniques may include using a confidence-level and quality metric designed to assess the accuracy of the inferred pick-up/drop-off locations, so that low quality pick-up/drop-off locations may be filtered out. Optimal parameters may be selected based on the GNSS pings' distribution.

The techniques may employ mean shift clustering algorithm to find clusters of GNSS pings (around the pick-up/drop-off time) and the local densest points (“cluster centroids”) of the found clusters. Then, as non-limiting examples, inferred or optimal pick-up/drop-off locations may be determined from those cluster centroids that may satisfy the criteria of confidence level, by determining the confidence level of the locations of the cluster centroids based on the cluster's probability computed via kernel density estimation (KDE), and the quality of the clusters, by determining a quality score or indicator for the locations of the cluster centroids.

Mean shift is a clustering algorithm that assigns the data points to the clusters iteratively by shifting points towards the mode, where the mode can be understood as the highest density of data points. An example of a mean shift algorithm for a set of data points X may include:
(i) For each datapoint x E X, find the neighbouring points N(x) of x (the neighbouring points are the points within a certain distance, this distance is referred to as mean shift bandwidth).
(ii) For each datapoint x E X, calculate the new mean m(x) using the equation

$$\text{?} ( x ) = \text{?} {x}_{i} . \qquad Equation ( 2 )$$

$$\text{?} \text{indicates text missing or illegible when filed}$$

(iii) For each datapoint x E X, update x F m(x).
(iv) Repeat (i) for n_iterations or until the points are almost not moving or not moving.

Kernel density estimation (KDE) is a non-parametric way to estimate the probability density function of a random variable. Let (x1, x2, . . . , xn) be a univariate independent and identically distributed sample drawn from some distribution with an unknown density f. Of interest is the estimation of the shape of this function f. Its kernel density estimator may be given by

$$\hat{{f}_{h}} ( x ) = \frac{1}{n} {{\sum }_{i = 1}}^{n} {K}_{h} ( x - {x}_{i} ) = \frac{1}{nh} {{\sum }_{i = 1}}^{n} K ( \frac{x - {x}_{i}}{h} ) , \qquad Equation ( 3 )$$

where K is the kernel (usually Gaussian) and h is referred as KDE bandwidth.

Generally, clustering algorithms may only give solution on how the data points are divided into different groups, but not information on whether the clusters (inferred or optimal pick-up/drop-off locations) are of a sufficient confidence level and good. The techniques disclosed herein may provide quantitative definition of confidence level and/or quality of clusters. Optimal pick-up/drop-off location's confidence level may be measured by the cluster's probability, e.g., computed via kernel density estimation (KDE). Optimal pick-up/drop-off location's quality may be described by a quality indicator or score. The quality indicator may be a function of mean shift bandwidth, maximum probability of clusters, average density of clusters (i.e., number of points over clusters' area) and the clusters' silhouette score. The cluster's probability and/or the quality indicator may be customised to the application of determining optimal pick-up/drop-off locations.

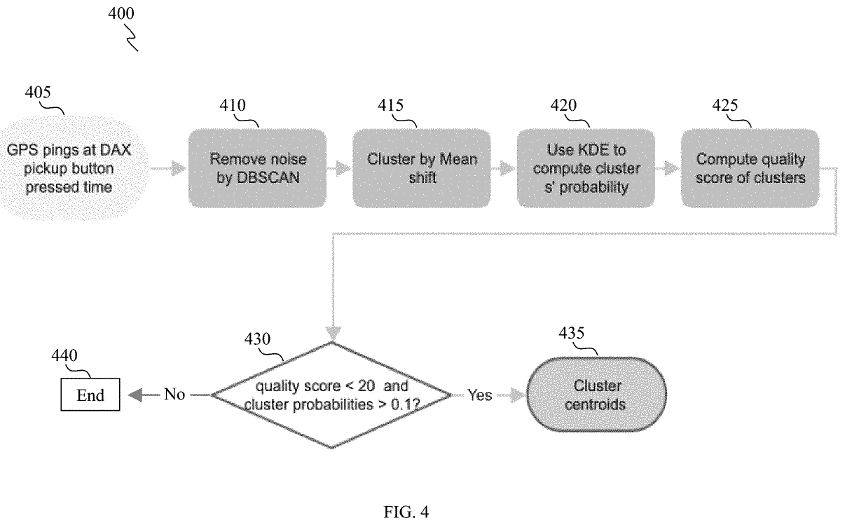

The techniques may work as illustrated in FIG. 4 showing a flow diagram of a method 400 for determining optimal pick-up/drop-off locations for transport services in accordance with another example implementation of the present disclosure.

At 405, GNSS pings (e.g., GPS pings) may be obtained via the DAX App and/or the PAX App. Preferably, GNSS pings (e.g., GPS pings) with low accuracy are removed.

At 410, DBSCAN clustering algorithm may be used to remove outliers which are points with low density. The DBSCAN algorithm views clusters as areas of high density separated by areas of low density. There are two parameters to the algorithm: “min_samples” which refers to the number of samples in a neighborhood for a point to be considered as a core point, and “eps” or eps (ε) which refers to the maximum distance between two samples for one to be considered to be in the neighborhood of the other. These parameters may define formally what is meant by “dense”. A higher min_samples or a lower eps may indicate higher density is required to form a cluster.

Using these two parameters, DBSCAN may categorise the data points into three categories:
1. Core Points: A data point p is a core point if E-neighborhood of p contains at least min_samples.
2. Border Points: A data point q is a border point if E-neighborhood of q contains less than min_samples data points, but q is reachable from some core point p.
3. Outlier: A data point o is an outlier if it is neither a core point nor a border point.

The ε-neighborhood of p (or q) is the circle of radius E, centered at p (or q).

At 415, mean shift clustering algorithm may be used to find the locally densest points (cluster centroids) of the GNSS pings around the pick-up/drop-off times. The mean shift clustering algorithm may also assign cluster membership to each of the GNSS pings, e.g., cluster 1 or 2 or 3, etc.

At 420, kernel density estimation (KDE) may be employed to compute the cluster's probabilities. A probability value is determined for each cluster.

At 425, the quality indicator or quality score of the clusters may be computed. Quality indicator is defined or determined based on data points across clusters.

At 430, the quality indicator and the probabilities may be checked against threshold values, e.g., quality indicator<20 and probabilities>0.1. For quality indicator, the threshold may be determined by heuristic and cumulative distribution function of quality indicator. Cluster probability may be determined by heuristic. It may be assumed that there are not more than 5 different pick-up points for one building, then the probability of significant clusters may be above 0.2. After taking into consideration noise, 0.1 may be used. These two thresholds are configurable and different values may be chosen to suit the applications.

A lower quality indicator may be related to a model with better defined clusters (e.g., each cluster is denser and different clusters are further apart). For cluster's probability, a higher value may indicate a lot of data points near that cluster's centroid (a lot of passengers get picked up/dropped off). Therefore, there is more confidence to designate the cluster's centroid as an optimal pick-up/drop-off location.

If the threshold requirements are satisfied, at 435, the cluster centroids of the clusters are designated as the optimal or inferred pick-up/drop-off locations. Optimal or inferred pick-up/drop-off locations make it easier for service users (e.g., passengers) and service providers (e.g., drivers) of transport services to find the correct pick-up/drop-off locations.

If the threshold requirements are not satisfied, the process ends at 440.

Bandwidth parameter that may be used in the mean shift algorithm and bandwidth parameter that may be used in KDE may be selected based on the DAX GNSS pings' distribution. One GNSS ping (e.g., GPS ping) refers to one pair of latitude and longitude or one point on the map or defined geographical area, i.e., (lat, Ion). A GNSS pings' distribution refers to how multiple (lat, Ion) pairs may be placed on the map or defined geographical area. It may be described by the set {(lat_i, lon_i)} for i=1 . . . N.

The bandwidth used in the mean shift algorithm may be selected via grid search so that the selected bandwidth may maximize the clusters' silhouette coefficient (silhouette score). Bandwidth parameter used in KDE may be selected via grid search so that the selected bandwidth may maximise the joint probability of all points.

The method 400 may be used to process historical data having geographical data points for a plurality of defined geographical areas for identifying corresponding cluster centroids that may be designated as the optimal or inferred pick-up/drop-off locations.

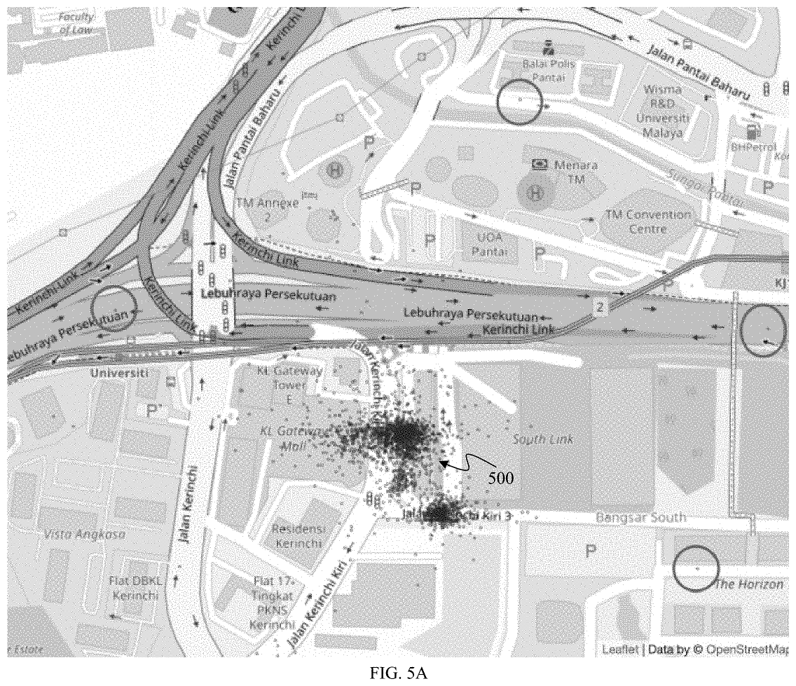

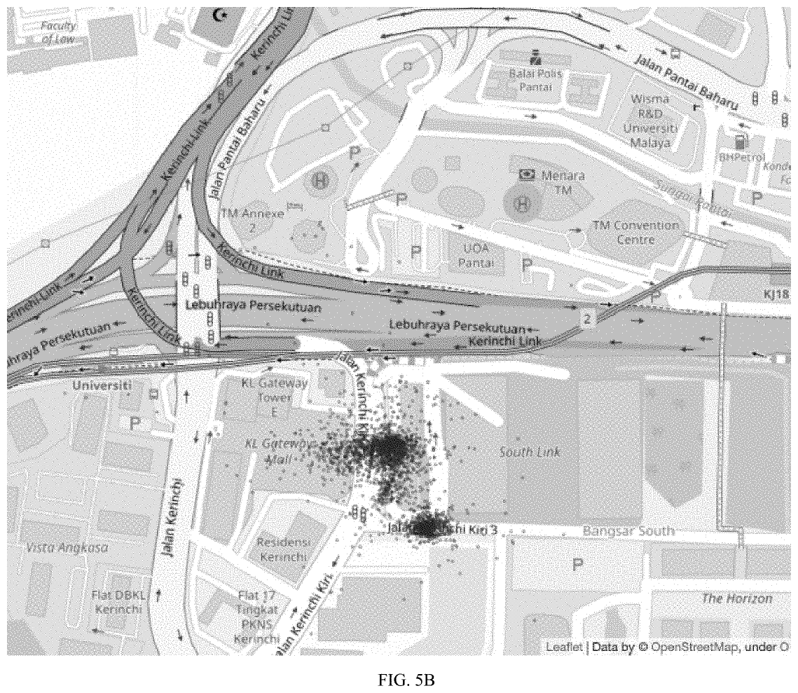

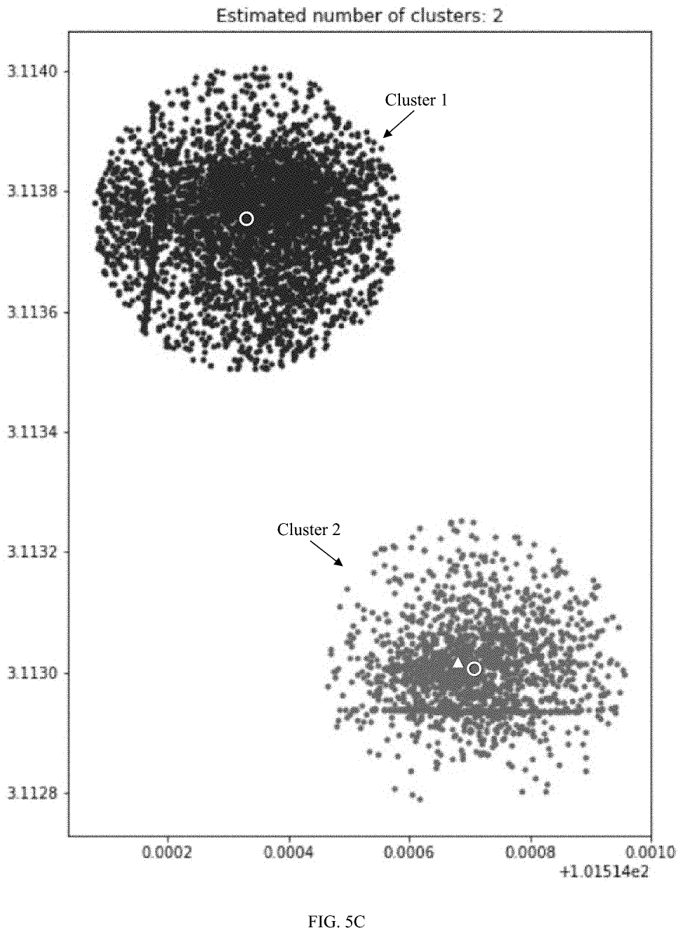

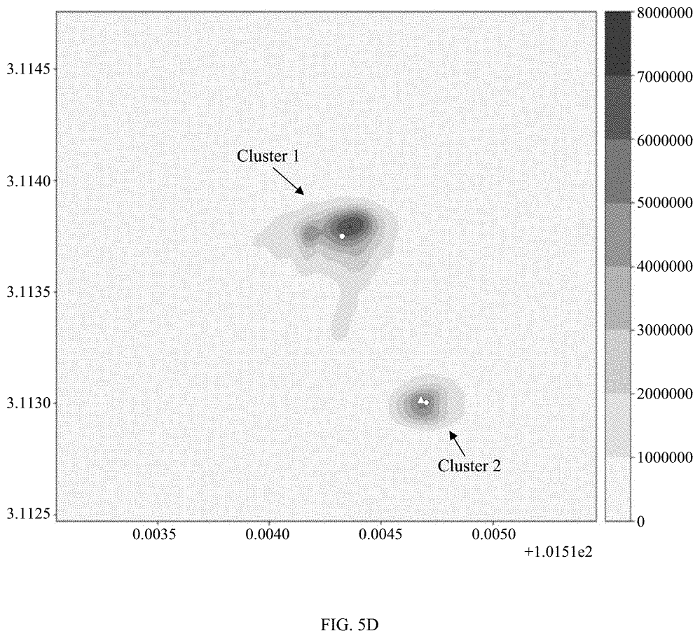

FIGS. 5A-D show maps illustrating example data points at various stages of the above described processing techniques. The non-limiting example provided below is described based on applying the techniques disclosed herein to find pick-up locations at “South View Serviced Apartments” in Kuala Lumpur, Malaysia.

Referring to FIG. 5A, when passengers (PAX) at the “South View Serviced Apartments” (generally indicated as 500) make a booking for transport services, drivers (DAX) go to the building to pick up PAX. As soon as PAX gets onto the DAX's car, DAX may press a button (e.g., via an App) to notify the system that DAX has picked up PAX. Then, the system may record the DAX GNSS pings at the moment the button is pressed. FIG. 5A shows DAX GNSS pings (when pick-up button is pressed) distribution for thousands of bookings (each dot represents one sample).

DBSCAN may be used to remove remote low density points, i.e., outliers. Referring to FIG. 5A again, the four points inside the respective circles, which are considered outliers, may be removed. FIG. 5B shows the results with the outliers removed.

Mean shift clustering may then be carried out. Referring to FIG. 5C, two clusters are found by mean shift clustering algorithm. The white circles represent the respective cluster's centroid. The data samples that are more than mean shift bandwidth away from the centroid is omitted. Therefore, the radius of the two clusters roughly represent the value of the mean shift bandwidth. In this example, mean shift bandwidth is about 28 meters. In FIG. 5C, the white triangle represents the coordinates of the POI (source location) that passengers have selected from the App while making a booking.

KDE may then be fitted to the data points to find each cluster's probability. FIG. 5D shows the probability density function (PDF) estimated via KDE. Each cluster's probability is obtained by integrating the PDF over the boundary box of each cluster's data points. The probability for cluster 1 that is obtained is 0.47, and the probability for cluster 2 is 0.21. Similar to those for FIG. 5C, the white circles and the white triangle shown in FIG. 5D refer respectively to the cluster centroids and the coordinates of the POI (source location) that passengers have selected from the App.

The quality indicator may then be computed based on the following.
Meanshift bandwidth=28 m,
Maximum cluster probability=0.47,
Silhouette score=0.80.
Total number of points in cluster 1=4004,
Total number of points in cluster 2=1832,
The effective radius of the cluster 1=24.47 m,
The effective radius of the cluster 2=20.82 m.
Average density may be determined by

$$Avg density = {\sum }_{cluster i} total number of points in cluster i / {\sum }_{cluster i} the area of cluster i . \qquad Equation ( 4 )$$

Therefore, average density=(4004+1832)/(24.47\hat{ }2+20.82\hat{ }2)=5.65.
With the above parameters, using Equation (1), the quality score is 1.34.

Based on the above, two optimal locations may be created using the clusters' centroids as the pick-up points for the building “South View Serviced Apartments” 500.

Aspects of the present disclosure are described herein with reference to flow diagrams. It will be understood that the steps in the illustrated implementations are by way of example. The steps may be carried out in any suitable order, and some of the steps may be omitted accordingly to application requirements. It will be understood that the steps of the flow diagrams, and combinations of steps, can be implemented by computer readable program instructions.

It will be appreciated that the invention has been described by way of example only. Various modifications may be made to the techniques described herein without departing from the spirit and scope of the appended claims. The disclosed techniques include techniques which may be provided in a stand-alone manner, or in combination with one another. Therefore, features described with respect to one technique may also be presented in combination with another technique.

1. A method for determining optimal pick-up/drop-off locations for transport services at a defined geographical area, the method comprising:
processing historical data associated with past bookings for the transport services, the past bookings having a pick-up or drop-off location within the defined geographical area, wherein each historical data instance for a booking comprises a geographical data point, recorded at a time of a pick-up/drop-off event, within the defined geographical area,
wherein processing the historical data comprises identifying clusters of geographical data points having similar geographical locations, wherein each cluster comprises a cluster centroid, the cluster centroid being a locally densest point for the cluster;
for each identified cluster,
determining a probability value for the identified cluster, wherein the probability value is a measure of the closeness of the geographical data points to the cluster centroid;
comparing the determined probability value with a second threshold; and
if the determined probability value satisfies the second threshold, designating the identified cluster as a significant cluster;
determining a quality indicator for the significant clusters;
comparing the determined quality indicator with a first threshold; and
if the determined quality indicator satisfies the first threshold, for each significant cluster, designating the cluster centroid of the significant cluster as an optimal pick-up/drop-off location for the defined geographical area.

2. The method as claimed in claim 1, further comprising:
prior to identifying the clusters of geographical data points having similar geographical locations, removing data points determined to be outliers.

3. The method as claimed in claim 1, wherein identifying the clusters of geographic data points having similar geographical locations comprises performing cluster analysis using a mean shift clustering algorithm.

4. The method as claimed in claim 3, wherein determining the quality indicator for the significant clusters comprises determining the quality indicator as a function of mean shift bandwidth, maximum probability of the significant clusters, average density of the significant clusters and silhouette coefficient of the significant clusters.

5. The method as claimed in claim 4, wherein the quality indicator is determined by the formula:
$$quality indicator = \sqrt{\frac{{( ms\_bandwidth / 10 )}^{1 / 3}}{max\_cluster {\_prob}^{2} \times avg\_density \times {sh\_score}^{2}}}$$
where:
avg_density=average density of the significant clusters,
ms_bandwidth=mean shift bandwidth,
sh_score=silhouette coefficient of the significant clusters,
max_cluster_prob=the maximum probability of the significant clusters.

6. (canceled)

7. The method as claimed in claim 1, wherein determining the probability value for the identified cluster comprises performing kernel density estimation (KDE) to obtain the 2D probability density function over the coordinate space of the identified cluster.

8. The method as claimed in claim 1, wherein each geographical data point has a specified accuracy, the method further comprising:
removing data points having a specified accuracy less than a threshold accuracy level.

9. The method as claimed in claim 1, wherein prior to processing the historical data associated with past bookings for the transport services, the method comprising:
mining data associated with past bookings for the transport services, wherein each historical data instance for a booking comprises a geographical data point recorded at a time of a pick-up/drop-off event; and
filtering the mined data to identify data instances for bookings, in which one of the geographical data points, corresponding to a pick-up or drop-off location for the booking, is within the defined geographical area.

10. The method as claimed in claim 1, wherein the defined geographical area corresponds to a point of interest or address, the method further comprising:
in response to a booking request from a service user for a transport service indicating the point of interest or address as the pick-up or drop-off location, communicating the determined optimal pick-up/drop-off locations to a client device of the service user for selection by the service user of one of the optimal pick-up/drop-off locations for the booking.

11. A processing apparatus for determining optimal pick-up/drop-off locations for transport services at a defined geographical area comprising a processor and a memory, the apparatus being configured, under control of the processor, to execute instructions in the memory to:
process historical data associated with past bookings for the transport services, the past bookings having a pick-up or drop-off location within the defined geographical area, wherein each historical data instance for a booking comprises a geographical data point, recorded at a time of a pick-up/drop-off event, within the defined geographical area,
wherein, for processing historical data, the apparatus is configured to identify clusters of geographical data points having similar geographical locations, wherein each cluster comprises a cluster centroid, the cluster centroid being a locally densest point for the cluster;
for each identified cluster,
determine a probability value for the identified cluster, wherein the probability value is a measure of the closeness of the geographical data points to the cluster centroid;
compare the determined probability value with a second threshold; and
if the determined probability value satisfies the second threshold, designate the identified cluster as a significant cluster;
determine a quality indicator for the significant clusters;
compare the determined quality indicator with a first threshold; and
if the determined quality indicator satisfies the first threshold, designate, for each significant cluster, the cluster centroid of the significant cluster as an optimal pick-up/drop-off location for the defined geographical area.

12. The apparatus as claimed in claim 11, being further configured to remove data points determined to be outliers, prior to identifying the clusters of geographical data points having similar geographical locations.

13. The apparatus as claimed in claim 11, wherein, for identifying the clusters of geographical data points having similar geographical locations, the apparatus is configured to perform cluster analysis using a mean shift clustering algorithm.

14. The apparatus as claimed in claim 13, wherein, for determining the quality indicator for the significant clusters, the apparatus is configured to determine the quality indicator as a function of mean shift bandwidth, maximum probability of the significant clusters, average density of the significant clusters and silhouette coefficient of the significant clusters.

15. (canceled)

16. The apparatus as claimed in claim 11, being configured to determine the probability value for the identified cluster by performing kernel density estimation (KDE) to obtain the 2D probability density function over the coordinate space of the identified cluster.

17. The apparatus as claimed in claim 11, wherein each geographical data point has a specified accuracy, the apparatus being configured to remove data points having a specified accuracy less than a threshold accuracy level.

18. The apparatus as claimed in claim 11, wherein prior to processing the historical data associated with past bookings for the transport services, the apparatus is configured:
to mine data associated with past bookings for the transport services, wherein each historical data instance for a booking comprises a geographical data point recorded at a time of a pick-up/drop-off event; and
to filter the mined data to identify data instances for bookings, in which one of the geographical data points, corresponding to a pick-up or drop-off location for the booking, is within the defined geographical area.

19. The apparatus as claimed in claim 11, wherein the defined geographical area corresponds to a point of interest or address, the apparatus being configured to, in response to a booking request from a service user for a transport service indicating the point of interest or address as the pick-up or drop-off location, communicate the determined optimal pick-up/drop-off locations to a client device of a service user for selection by the service user of one of the optimal pick-up/drop-off locations for the booking.

20. A computer program or a computer program product comprising instructions for implementing the method as claimed in claim 1.

21. A non-transitory storage medium storing instructions, which, when executed by a processor, cause the processor to perform the method of claim 1.

22. A communications system for determining optimal pick-up/drop-off locations for transport services at a defined geographical area, comprising a communications server apparatus, at least one user communications device and communications network equipment operable for the communications server apparatus and the at least one user communications device to establish communication with each other therethrough,
wherein the communications server apparatus comprises a first processor and a first memory, the communications server apparatus being configured, under control of the first processor, to execute first instructions in the first memory to:
process historical data associated with past bookings for the transport services, the past bookings having a pick-up or drop-off location within the defined geographical area, wherein each historical data instance for a booking comprises a geographical data point, recorded at a time of a pick-up/drop-off event, within the defined geographical area,
wherein, for processing historical data, the communications server apparatus is configured to identify clusters of geographical data points having similar geographical locations, wherein each cluster comprises a cluster centroid, the cluster centroid being a locally densest point for the cluster;
for each identified cluster,
determine a probability value for the identified cluster, wherein the probability value is a measure of the closeness of the geographical data points to the cluster centroid;
compare the determined probability value with a second threshold; and
if the determined probability value satisfies the second threshold, designate the identified cluster as a significant cluster;
determine a quality indicator for the significant clusters;
compare the determined quality indicator with a first threshold; and
if the determined quality indicator satisfies the first threshold, designate, for each significant cluster, the cluster centroid of the significant cluster as an optimal pick-up/drop-off location for the defined geographical area;
wherein the at least one user communications device comprises a second processor and a second memory, the at least one user communications device being configured, under control of the second processor, to execute second instructions in the second memory to:
in response to receiving user booking request data for a transport service from a service user of the at least one user communications device, the user request data comprising a data field indicative of a point of interest or address corresponding to the defined geographical area, and the point of interest or address being the pick-up or drop-off location, communicate data indicative of the user booking request data to the communications server apparatus; and
wherein, in response to receiving the data indicative of the user booking request data, the communications server apparatus is configured to communicate the determined optimal pick-up/drop-off locations to the at least one user communications device for selection by the service user of one of the optimal pick-up/drop-off locations for the booking.
